(19) United States
(12) Patent Application Publication
(10) Pub. No.: US 2015/0130433 A1
(43) Pub. Date: May 14, 2015

(54) CONSTANT POWER AVAILABILITY FOR LOAD SWITCHES WITH FOLDBACK CURRENT

(71) Applicant: Fairchild Semiconductor Corporation, San Jose, CA (US)

(72) Inventors: Hrvoje Jasa, Scarborough, ME (US); Steven Macaluso, Scarborough, ME (US)

(21) Appl. No.: 14/535,617

(22) Filed: Nov. 7, 2014

Related U.S. Application Data
(60) Provisional application No. 61/901,591, filed on Nov. 8, 2013.

(51) Int. Cl. G05F 1/625

(52) U.S. Cl. CPC G05F 1/625
USPC 323/274

(57) ABSTRACT

Load switch supply circuits and methods are provided that allow a load switch to maintain power delivery without having the load switch encounter thermal or power overload conditions. In an example, a load switch supply circuit can include a multiplier circuit configured to receive a first representation of voltage across a load switch and a representation of current provided by the load switch and to provide a representation of power dissipated by the load switch, and a control amplifier configured to compare the representation of power dissipated by the load switch to a power threshold and to adjust a control terminal of the load switch to avoid cycling the load switch to an off state due to thermal overload or power overload conditions.

### CLAIM OF PRIORITY AND RELATED APPLICATION

This application claims the benefit of priority under 35 U.S.C. 119(e) to Jasa et al., U.S. Provisional Patent Application No. 61/901,591, filed on Nov. 8, 2013, and titled, “CONSTANT POWER AVAILABILITY FOR LOAD SWITCHES WITH FOLDBACK CURRENT,” which is hereby incorporated by reference herein in its entirety.

### BACKGROUND

Electronic devices can use load switches to distribute power from a power source to one or more sub systems or accessories of the electronic device. The load switches can be sized based on several criteria. In certain applications, subsystem or accessory power demands can exceed a maximum thermal rating of the load switch. Existing thermal limiting techniques can include severely limiting current or voltage to a load receiving power from the load switch. Such severe thermal limiting, or cycling, can render the subsystem or accessory useless for an extended time such as until the temperature or thermal stress of the load switch is well under the thermal limit threshold.

### OVERVIEW

Load switch supply circuits and methods are provided that allow a load switch to maintain power delivery without having the load switch encounter thermal or power overload conditions. In an example, a load switch supply circuit can include a multiplier circuit configured to receive a first representation of voltage across a load switch and a representation of current provided by the load switch and to provide a representation of power dissipated by the load switch, and a control amplifier configured to compare the representation of power dissipated by the load switch to a power threshold and to adjust a control terminal of the load switch to avoid cycling the load switch to an off state due to thermal overload or power overload conditions.

This overview is intended to provide a partial summary of the subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example supply circuit for delivering maximum power to a load switch.

FIG. 2 illustrates generally a flowchart of an example method of controlling thermal stress of a load switch.

FIGS. 3A and 3B illustrate graphically the differences between a traditional current foldback control of a load switch and a power control of a load switch according to the present subject matter.

### DETAILED DESCRIPTION

The present inventors have recognized apparatus and method for limiting thermal stress of a load switch without completely cycling power to a load receiving power from the load switch. It is not uncommon for a subsystem of an electronic system or an accessory of an electronic system to demand varying amounts of power. In some systems, power demand can exceed thermal limitations of a load switch. Existing systems often open the load switch to prevent thermal damage of the load switch. The load switch can remain open for an extended period to allow the load switch to cool to a thermal stress level well under a maximum thermal stress level. During the power off cycle interval, the load coupled to the load switch receives little if any power thus rendering any use, even partial use, of the subsystem or accessory unavailable.

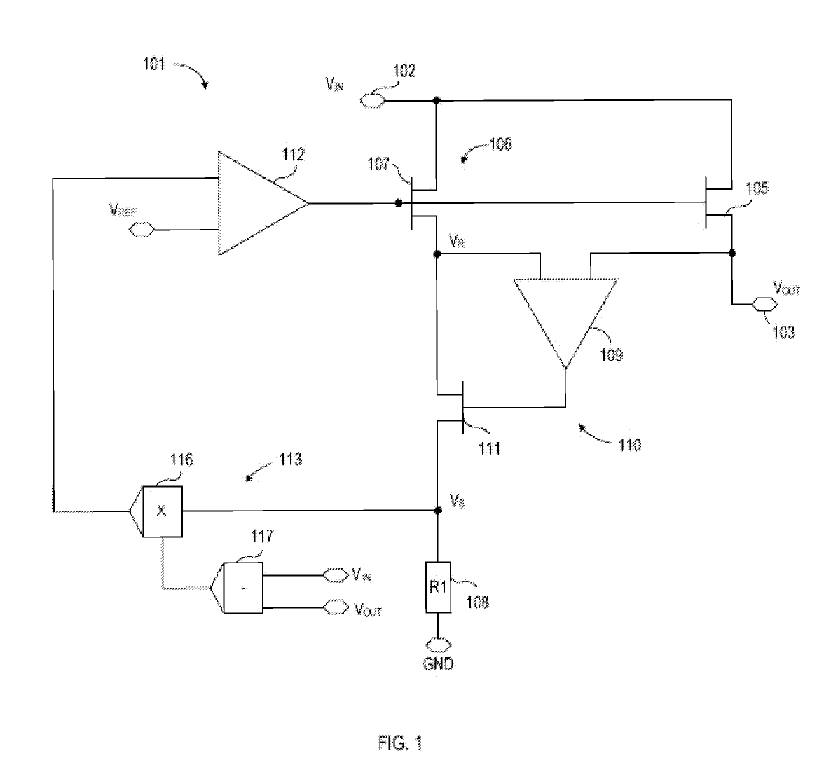

FIG. 1 illustrates generally an example supply circuit 100 for delivering maximum power to a load switch 105. In certain examples, the supply circuit 100 can accommodate and allow maximum current for a given voltage drop across the load switch 105 without exceeding a maximum thermal rating of the load switch 105. In certain examples, the supply circuit 100 is tailored to keep power constant as load requirements change. In certain examples, the supply circuit 100 can include a current sense circuit 106, a power sense circuit 113, and a control amplifier 112. The current sense circuit 106 can provide a representation of the current flowing through the load switch 105. The power sense circuit 113 can include an voltage sense circuit 117 configured to receive the supply voltage level (V_{IN}) and the output voltage level (V_{OUT}) and to provide a representation of the voltage across the load switch 105. The power sense circuit 113 can also include a multiplier circuit 116 configured to receive the representation of the voltage across the load switch 105 and the output (V_{S}) of the current sense circuit 106 and to provide a representation of the power dissipation of the load switch 105. In certain examples, the control amplifier 112 can compare the representation of the power dissipation of the load switch 105 to a target power (V_{REF}) and can modulate a control node of the load switch 105 such that the load switch 105 provides as much current as possible without exceeding a thermal rating of the load switch 105. In certain examples, the control amplifier 112 can include one or more processors to modulate the control node of the load switch 105. In some examples, additional criteria can be processed by the control amplifier 112 to modulate the control node of the load switch 105, for example, an enable input can control whether the load switch 105 can conduct current to a load coupled to an output terminal 103 or isolate the supply voltage (V_{IN}) from the load.

In certain examples, the current sense circuit 106 can include a scaled load switch 107, and a feedback circuit 110 to modulate the state of the scaled load switch 107 with the state of the actual load switch 105. In some examples, the scaled load switch 107 can operate and be coupled in parallel with the load switch 105. In certain examples, the feedback circuit 110 can include a feedback transistor 111 and a feedback amplifier 109. The feedback amplifier 109 can compare the output voltage (V_{OUT}) of the load switch 105 with the voltage (V_{R}) at a parallel terminal of the scaled load switch 107. The output of the feedback amplifier 109 can modulate a control node of the feedback transistor 111 to maintain the parallel node of the scaled load switch 107 at a voltage (V_{R}) corresponding to the output voltage (V_{OUT}).

In certain examples, the current sense circuit 106 can include a sense resistor 108 corresponding to a load that can be coupled to the load switch 105. In certain examples, the sense resistor 108 can provide a representation of the load current (Vs). Multiplying the representation of the load current (Vs) with a representation of the voltage across the load switch 105 can provide a representation of the power dissipated by the load switch 105.

In certain examples, the difference between the supply voltage (V_{IN}) and the output voltage (V_{OUT}) can provide the representation, if not the exact value, of the voltage across the load switch 105. In certain examples, the power sense circuit 113 can include a voltage sense circuit 117, such as an amplifier, to receive the output voltage (V_{OUT}) and the supply voltage (V_{IN}) and provide a representation of the voltage across the load switch 105.

In certain examples, the power sense circuit 113 can include a multiplier circuit 116 to multiply the representation of the load current (Vs) with the representation of the voltage across the load switch 105 to provide a representation of the power dissipated by the load switch 105. In some examples, the power sense circuit 113 can include one or more processor to receive the load current information, such as the representation of the load current, and the load switch voltage information, such as the representation of the voltage across the load switch, to provide power information, including power information representative of the power dissipated by the load switch 105.

In certain examples, the control amplifier 112 can compare the representation of the power dissipation of the load switch 105 to target power information (V_{REF}) and can modulate a control node of the load switch 105 such that the load switch 105 provides as much current as possible without exceeding a thermal rating of the load switch 105. In certain examples, the control amplifier 112 can include one or more processors to modulate the control node of the load switch 105. In some examples, additional criteria can be processed by the control amplifier to modulate the control node of the load switch 105, for example, an enable input can control whether the load switch can conduct current to the load or isolate the supply voltage from the load or one or more additional sensors can provide ambient temperature, humidity or other thermodynamic information relevant to thermal stress of the load switch.

In certain examples, the scaled load switch 107 can be configured to provide a scaled current indicative of the load current for a given voltage at the control nodes of the load switch 105 and the scaled load switch 107, such that the sense voltage across the sense resistor is given by,

$${V}_{s} = \frac{{I}_{load}}{X} {R}_{1} ,$$

where I_{load} is the current provided to the load, X is the ratio of the output load switch 105 to the scaled load switch 107, and R₁ is the resistance or impedance of the sense impedance 108. The voltage across the load switch 105 can be given by,

V₁=V_{IN}−V_{OUT},
where V_{IN} is the voltage of the supply power received at a supply input 102 and V_{OUT} is the voltage provided to a load coupled to the output 103 of the supply circuit 100. In certain examples, the load switch 105 can include a power transistor such as a power metal oxide semiconductor field effect transistor (MOSFET), thus, the voltage across the load switch 105 can equal the voltage across the drain and the source terminals of the transistor (V_{ds}). As discussed above, the power sense circuit 113 can include a multiplier circuit 116 to multiply the representation of the load current (V_{S}) with the representation of the voltage across the load switch 105 to provide a representation of the power dissipated by the load switch 105. The output of the multiplier circuit 116 can be given by,

$${V}_{c} = {V}_{ds} \cdot \frac{{I}_{load}}{X} {R}_{1} .$$

where V_{c} includes a representation of the power dissipated in the load switch 105. Load switch power (P_{LS}) can be given by the voltage across the load switch (V_{ds}) times the load current (I_{load}), thus,

$${V}_{c} = {P}_{LS} \cdot \frac{{R}_{1}}{X}$$

In certain examples, the representation of the power dissipated in the load switch (Vc) can be compared to a target power value (V_{REF}), or a representation of a target power value, to modulate the load current and prevent the load switch 105 from dissipating power in excess of a rated power value of the load switch 105.

Such control can maintain a maximum amount of power flowing to a load without requiring the load to be isolated from the power supply, for example, to allow the load switch to recuperate from exceeding a thermal stress level beyond a rated thermal stress level. As a result, some operational aspects of a load may be able to be maintained even though power demand of the load exceeds the capability of the load switch. Thus, some aspects of the subsystem load, or accessory load, can remain useful during high power demand intervals instead of isolating the subsystem load or accessory load from the power supply until the load switch has recovered from an excess power interval. In addition to maintaining the operational usefulness of a subsystem or accessory, the control aspects discussed above can reduce intermittent thermal stress of the load switch which, in certain examples, can extend the life of the load switch.

In certain examples, the target power value (V_{REF}), or the representation of a target power value, can be programmable. In some examples, the target power value (V_{REF}), or the representation of a target power value, can be programmable using an external component such as an external resistor coupled to the supply circuit 100. In certain examples, the supply circuit 100 can be fabricated on an integrated circuit chip. In certain examples, mobile electronic devices can employ a supply circuit 100 as discussed above to supply power to one or more subsystems. Such mobile devices can include, but are not limited to, handheld communication devices, personal digital assistants, mobile entertainment devices, cellular phones, smart phones, and tablet devices. Subsystems, can include, but are not limited to, cameras, illumination devices, indicators, audio transducers, wireless transmission circuits, operator interface systems such as screens and touch sensitive transducers, and sensors, including but not limited to, thermometers, gyroscopes and accelerometers. Accessories can include, but are not limited to, universal serial bus (USB) compatible devices and chargers.

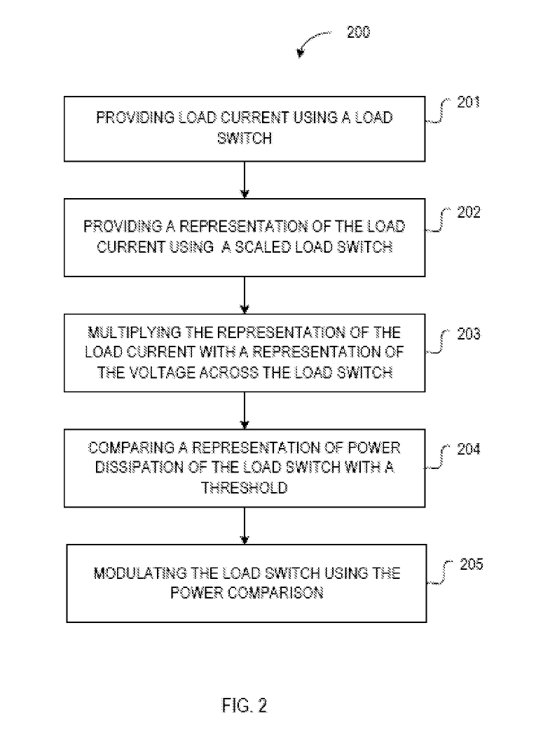

FIG. 2 illustrates generally a flowchart of an example method 200 of controlling thermal stress of a load switch. The method can include at 201, providing a load current at an output voltage to a load using a load switch. At 202, providing a representation of the load current using a scaled load switch operated in parallel with the load switch. At 203, multiplying the representation of the load current with a representation of the voltage across the load switch to provide a representation of power dissipated in the load switch using a load multiplier circuit. At 204, comparing the representation of power dissipated in the load switch with a threshold, and at 205, modulating a control node of the load switch and a control node of the scaled load switch using the comparison of the representation of power dissipated in the load switch with a threshold.

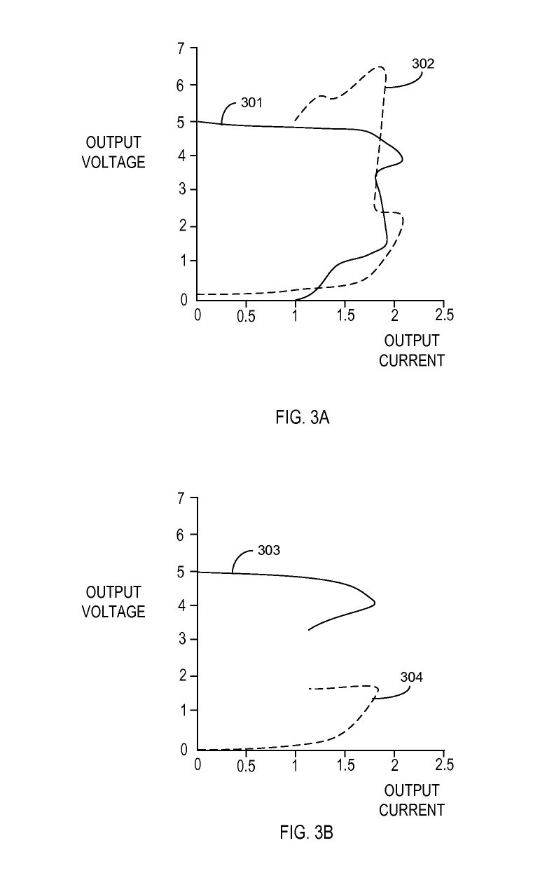

FIGS. 3A and 3B illustrate graphically the differences between a traditional current foldback control of a load switch and a power control of a load switch according to the present subject matter. FIG. 3A illustrates a traditional foldback current scenario as the output voltage across the load switch varies. The plot of FIG. 3A includes a first plot 301 of the output voltage versus the foldback current and a second plot 302 of the corresponding power. In certain applications, load current can be too high for the load switch package and can trigger a thermal shutdown. Such a shutdown can result in thermal or power cycling of the load which can render the entire functionality of the load useless during the shutdown time. FIG. 3B illustrates generally load current of an example supply circuit as the output voltage across the load switch varies and modulates the current to within the thermal limits of the package. FIG. 3B includes a third plot 303 of the output voltage versus the foldback current and a fourth plot 304 of the corresponding power. Such modulation or adjustment of the output current can prevent thermal or power cycling and can allow at some load systems to remain functional.

### EXAMPLES AND NOTES

In Example 1, a load switch supply circuit can include a multiplier circuit configured to receive a first representation of voltage across a load switch and a representation of current provided by the load switch and to provide a representation of power dissipated by the load switch, and a control amplifier configured to compare the representation of power dissipated by the load switch to a power threshold and to adjust a control terminal of the load switch to avoid cycling the load switch to an off state due to thermal overload or power overload conditions.

In Example 2, the supply circuit of claim 1 optionally includes a power sense circuit including the multiplier circuit and a current sense circuit.

In Example 3, the current sense circuit of any one or more of Examples 1-2 optionally includes a scaled load switch configured to couple in parallel with the load switch, and a feedback circuit configured to modulate a state of the scaled load switch.

In Example 4, the feedback circuit of any one or more of Examples 1-3 optionally includes a feedback transistor coupled in series with the scaled load switch, and a feedback amplifier configured to receive a second representation of the output voltage and a feedback voltage at a feedback node common to the feedback transistor and the scaled load switch.

In Example 5, the feedback amplifier of any one or more of Examples 1-4 optionally is configured to compare the second representation of the output voltage and the feedback voltage and to modulate a control node of the feedback transistor to reduce a difference between the feedback voltage and the second representation of the output voltage.

In Example 6, the second representation of the output voltage of any one or more of Examples 1-5 optionally is the output voltage at the load switch.

In Example 7, the current sense circuit of any one or more of Examples 1-6 optionally includes a sense resistor configured to provide the representation of current provided by the load switch.

In Example 8, the control amplifier of any one or more of Examples 1-7 optionally includes an enable input configured to receive a load switch enable signal, wherein an output of the control amplifier is configured to adjust a control terminal of the load switch to avoid cycling the load switch to the off state responsive to enable input in a first state and to place the load switch in the off state responsive to enable input in a second state.

In Example 9, a method of reducing load switch cycling can include receiving a first representation of voltage across a load switch at a multiplier circuit, receiving a representation of current provided by the load switch at the multiplier circuit, providing a representation of power dissipated by the load switch at an output of the multiplier circuit, comparing the representation of power dissipated by the load switch with a power reference and a control amplifier, and adjusting a control terminal of the load switch using an output of the control amplifier to avoid cycling the load switch to an off state due to thermal overload or power overload conditions.

In Example 10, the receiving a representation of current provided by the load switch at the multiplier circuit of any one or more of Examples 1-9 optionally includes adjusting a control terminal of a scaled load switch using the output of the control amplifier.

In Example 11, the receiving a representation of current provided by the load switch at the multiplier circuit of any one or more of Examples 1-10 optionally includes sensing a current passing through the scaled load switch at a current sense resistor.

In Example 12, the receiving the representation of current of any one or more of Examples 1-11 optionally includes receiving a voltage across the sense resistor at the multiplier circuit.

In Example 13, the sense resistor of any one or more of Examples 1-12 optionally is coupled in series with the scaled load switch.

In Example 14, the receiving a representation of current provided by the load switch at the multiplier circuit of any one or more of Examples 1-13 optionally includes adjusting a control terminal of a feedback transistor coupled in series with the scaled load switch.

In Example 15, the adjusting a control terminal of a feedback transistor of any one or more of Examples 1-14 optionally includes receiving a second representation of the output voltage at a feedback amplifier, receiving a feedback voltage at the feedback amplifier, wherein a node common to the scaled load switch and the feedback transistor is configured to provide the feedback voltage, and providing an output of the feedback amplifier to the control node of the feedback transistor.

In Example 16, the receiving the second representation of the output voltage of any one or more of Examples 1-15 optionally includes receiving the output voltage directly at the feedback amplifier.

In Example 17, a power distribution circuit can include a load switch and a load switch supply circuit. The load switch supply circuit can include a multiplier circuit configured to receive a first representation of voltage across the load switch and a representation of current provided by the load switch and to provide a representation of power dissipated by the load switch, and a control amplifier configured to compare the representation of power dissipated by the load switch to a power threshold and to adjust a control terminal of the load switch to avoid cycling the load switch to an off state due to thermal overload or power overload conditions.

In Example 18, the load switch supply circuit of any one or more of Examples 1-17 optionally includes a power sense circuit including the multiplier circuit and a current sense circuit.

In Example 19, the current sense circuit of any one or more of Examples 1-18 optionally includes a scaled load switch configured to couple in parallel with the load switch and a feedback circuit configured to modulate a state of the scaled load switch.

In Example 20, the feedback circuit of any one or more of Examples 1-19 optionally includes a feedback transistor coupled in series with the scaled load switch and a feedback amplifier configured to receive a second representation of the output voltage and a feedback voltage at a feedback node common to the feedback transistor and the scaled load switch.

Example 21 can include, or can optionally be combined with any portion or combination of any portions of any one or more of Examples 1 through 20 to include, subject matter that can include means for performing any one or more of the functions of Examples 1 through 20, or a machine-readable medium including instructions that, when performed by a machine, cause the machine to perform any one or more of the functions of Examples 1 through 20.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A load switch supply circuit comprising:
a multiplier circuit configured to receive a first representation of voltage across a load switch and a representation of current provided by the load switch and to provide a representation of power dissipated by the load switch; and
a control amplifier configured to compare the representation of power dissipated by the load switch to a power threshold and to adjust a control terminal of the load switch to avoid cycling the load switch to an off state due to thermal overload or power overload conditions.

2. The supply circuit of claim 1, including a power sense circuit including the multiplier circuit and a current sense circuit.

3. The supply circuit of claim 2, wherein the current sense circuit includes:
a scaled load switch configured to couple in parallel with the load switch; and
a feedback circuit configured to modulate a state of the scaled load switch.

4. The supply circuit of claim 3, wherein the feedback circuit includes:
a feedback transistor coupled in series with the scaled load switch; and
a feedback amplifier configured to receive a second representation of the output voltage and a feedback voltage at a feedback node common to the feedback transistor and the scaled load switch.

5. The supply circuit of claim 4, wherein the feedback amplifier is configured to compare the second representation of the output voltage and the feedback voltage and to modulate a control node of the feedback transistor to reduce a difference between the feedback voltage and the second representation of the output voltage.

6. The supply circuit of claim 5, wherein the second representation of the output voltage is the output voltage at the load switch.

7. The supply circuit of claim 2, wherein the current sense circuit includes a sense resistor configured to provide the representation of current provided by the load switch.

8. The supply circuit of claim 1, wherein the control amplifier includes an enable input configured to receive a load switch enable signal, wherein an output of the control amplifier is configured to adjust a control terminal of the load switch to avoid cycling the load switch to the off state responsive to enable input in a first state and to place the load switch in the off state responsive to enable input in a second state.

9. A method of reducing load switch cycling, the method comprising:
receiving a first representation of voltage across a load switch at a multiplier circuit;
receiving a representation of current provided by the load switch at the multiplier circuit;
providing a representation of power dissipated by the load switch at an output of the multiplier circuit;
comparing the representation of power dissipated by the load switch with a power reference and a control amplifier; and
adjusting a control terminal of the load switch using an output of the control amplifier to avoid cycling the load switch to an off state due to thermal overload or power overload conditions.

10. The method of claim 9, wherein the receiving a representation of current provided by the load switch at the multiplier circuit includes adjusting a control terminal of a scaled load switch using the output of the control amplifier.

11. The method of claim 9, wherein the receiving a representation of current provided by the load switch at the multiplier circuit includes sensing a current passing through the scaled load switch at a current sense resistor.

12. The method of claim 11, wherein the receiving the representation of current includes receiving a voltage across the sense resistor at the multiplier circuit.

13. The method of claim 11, wherein the sense resistor is coupled in series with the scaled load switch.

14. The method of claim 10, wherein the receiving a representation of current provided by the load switch at the multiplier circuit includes adjusting a control terminal of a feedback transistor coupled in series with the scaled load switch.

15. The method of claim 10, wherein the adjusting a control terminal of a feedback transistor includes:
receiving a second representation of the output voltage at a feedback amplifier;
receiving a feedback voltage at the feedback amplifier, wherein a node common to the scaled load switch and the feedback transistor is configured to provide the feedback voltage; and
providing an output of the feedback amplifier to the control node of the feedback transistor.

16. The method of claim 15, wherein the receiving the second representation of the output voltage includes receiving the output voltage directly at the feedback amplifier.

17. A power distribution circuit comprising:
a load switch; and
a load switch supply circuit;
wherein the load switch supply circuit includes:
a multiplier circuit configured to receive a first representation of voltage across the load switch and a representation of current provided by the load switch and to provide a representation of power dissipated by the load switch; and
a control amplifier configured to compare the representation of power dissipated by the load switch to a power threshold and to adjust a control terminal of the load switch to avoid cycling the load switch to an off state due to thermal overload or power overload conditions.

18. The power distribution circuit of claim 17, wherein the load switch supply circuit includes a power sense circuit including the multiplier circuit and a current sense circuit.

19. The power distribution circuit of claim 18, wherein the current sense circuit includes:
a scaled load switch configured to couple in parallel with the load switch; and
a feedback circuit configured to modulate a state of the scaled load switch.

20. The power distribution circuit of claim 19, wherein the feedback circuit includes:
a feedback transistor coupled in series with the scaled load switch; and
a feedback amplifier configured to receive a second representation of the output voltage and a feedback voltage at a feedback node common to the feedback transistor and the scaled load switch.
